(19) United States
(12) Patent Application Publication
(10) Pub. No.: US 2004/0148209 A1
(43) Pub. Date: Jul. 29, 2004

(54) System and method for producing an infrastructure project estimate for information technology

(76) Inventors: David E. Church, Orion Township, MI (US); Aric V. Rohner, Raleigh, NC (US)

Correspondence Address: BAKER BOTTS L.L.P., 2001 ROSS AVENUE, 6TH FLOOR, DALLAS, TX, 75201, US

(21) Appl. No.: 10/353,371

(22) Filed: Jan. 28, 2003

(51) Int. Cl. G06F 17/60

(52) U.S. Cl. 705/7

(57) ABSTRACT

A method for producing an infrastructure project estimate comprises identifying a plurality of infrastructure elements, the infrastructure elements comprising operating environments, software, interfaces, service, and documentation. A project model is loaded with the plurality of infrastructure elements. At least one attribute is selected for each infrastructure element in the project model. The method processes at least a portion of the project model based on each selected attribute and produces an infrastructure project estimate based on the processed project model, the estimate comprising project cost and project duration.

### TECHNICAL FIELD OF THE INVENTION

This invention relates generally to project estimates and, more specifically, to producing an infrastructure project estimate for information technology.

### BACKGROUND OF THE INVENTION

Project estimates provide businesses cost and time estimates for various projects. These estimates may be used by businesses for internal jobs or for external efforts for clients. Traditionally, there is no consistent approach to infrastructure project estimating for information technology as there is no unit of measure for IT infrastructure. This results in a lack of precision for IT infrastructure project estimates, which causes miscommunications between business units and, occasionally, an expenditure of resources in re-estimating the projects to achieve a more precise estimate. These conventional infrastructure project estimates do not have a consistent source of information on how previous infrastructure projects were estimated. Consequently, current infrastructure project estimates do not include substantially defined or consistent project requirements.

### SUMMARY OF THE INVENTION

In accordance with the present invention, the disadvantages and problems associated with producing an infrastructure project estimate for information technology have been substantially reduced or eliminated.

In one embodiment, a method for producing an infrastructure project estimate comprises identifying a plurality of infrastructure elements, the infrastructure elements comprising operating environments, software, interfaces, service, and documentation. A project model is loaded with the plurality of infrastructure elements. At least one attribute is selected for each infrastructure element in the project model. The method processes at least a portion of the project model based on each selected attribute and produces an infrastructure project estimate based on the processed project model, the estimate comprising project cost and project duration.

Certain embodiments may provide one or more technical advantages, one or more of which may be readily apparent to those skilled in the art from the figures, description and claims included herein.

### BRIEF DESCRIPTION OF THE DRAWINGS

For a more complete understanding of the present invention and its advantages, reference is now made to the following descriptions, taken in conjunction with the accompanying drawings, in which:

FIG. 1 illustrates one embodiment of a system for producing an infrastructure project estimate for information technology;

FIG. 2 illustrates one embodiment of a command module of the system in FIG. 1;

FIGS. 3A-3D illustrate exemplary displays of a graphical user interface supported by the system of FIG. 1;

FIG. 4 illustrates one embodiment of an identification module of the system in FIG. 1;

FIGS. 5A-5C illustrate a graphical project diagram of infrastructure elements in accordance with the system of FIG. 1;

FIG. 6 illustrates one embodiment of a loading module of the system in FIG. 1;

FIG. 7 illustrates one embodiment of an assumption identification module of the system in FIG. 1;

FIG. 8 illustrates one embodiment of an estimating module of the system in FIG. 1;

FIGS. 9A-9B illustrate operation of an ABCD matrix for risk assessment for use by the estimating module of FIG. 8;

FIG. 10 illustrates one embodiment of a result module of the system in FIG. 1; and

FIG. 11 illustrates a flow chart of an exemplary method for producing an infrastructure project estimate for information technology.

### DETAILED DESCRIPTION OF EXAMPLE EMBODIMENTS OF THE INVENTION

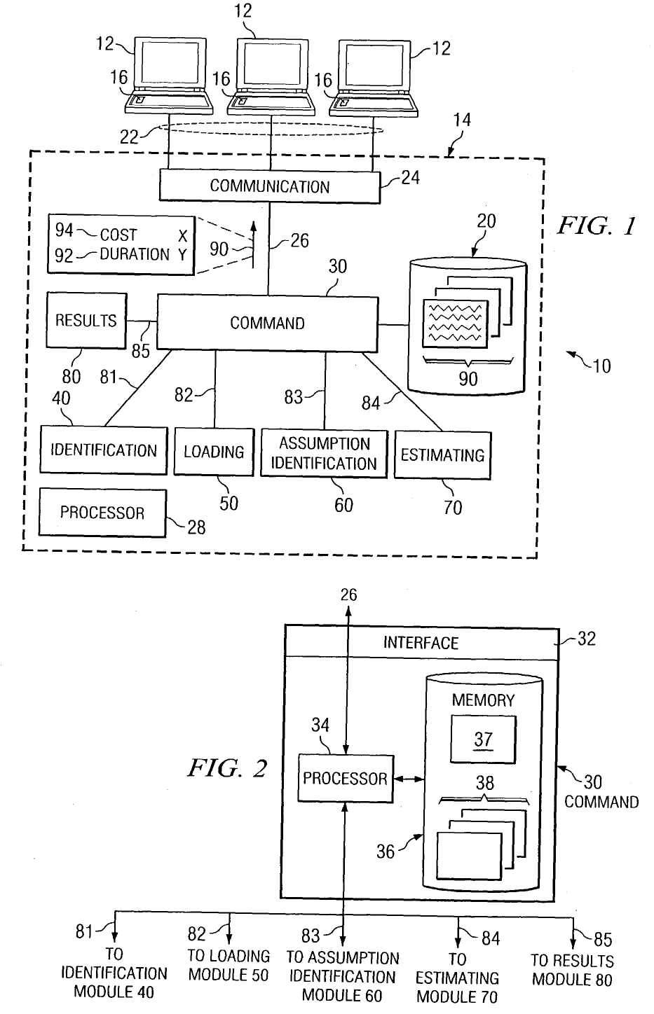

FIG. 1 illustrates one embodiment of a system 10 for producing an infrastructure project estimate 90 for information technology (IT). Generally, infrastructure project estimate 90 includes a dynamically determined project duration 92 and project cost 94 based on input from one or more clients 12. Each project estimate 90 for IT is based on input regarding infrastructure elements. Infrastructure elements are the lowest level of project granularity within an IT project. In other words, infrastructure elements represent substantially every principal component of a project that should be considered when producing project estimate 90. Infrastructure elements may include operating environments, software, interfaces, services, and documentation. In general, system 10 efficiently and accurately creates infrastructure project estimate 90 based on the infrastructure elements identified in the project and reusable information from historical project estimates 90 or from expert analysis. In this respect, system 10 provides infrastructure project estimates 90, which are measurable, reliable, and consistent, to one or more clients 12.

System 10 includes a server 14 coupled to a variety of clients 12 referred to generally in the singular as client 12 or in the plural as clients 12. In general, client 12 uses infrastructure project estimating application 16 to input various project information to server 14 and receive project estimate 90 in return. Client 12 may include input devices, output devices, mass storage media, processors, memory, or other appropriate components for executing infrastructure project estimating application 16 using server 14.

Infrastructure project estimating application 16 generally provides estimates 90 to information technology engineers and managers operating clients 12. As used in this document, client 12 is intended to encompass a personal computer, workstation, network computer, kiosk, wireless data port, datashow, wireless telephone, personal digital assistant (PDA), one or more processors within these or other devices, or any other suitable processing device. For example, client 12 may comprise a computer that includes an input device, such as a keypad, touch screen, mouse, or other device that can accept information, and an output device that conveys information associated with the operation of server 14 or clients 12, including digital data, visual information, or audio information. Both the input device and output device may include fixed or removable storage media such as a magnetic computer disk, CD-ROM, or other suitable media to both receive input from and provide output to users of clients 12. It will be understood that there may be any number of clients 12 coupled to server 14.

Although server 14 and clients 12 are referred to in the nomenclature of a client/server environment, it should be understood that server 14 and clients 12 may be any type of computer operating in any suitable environment that may communicate using hardware and software associated with link 22. For example, the components in system 10 may be arranged in a peer-to-peer computing environment. Or, in the alternative, it will be understood that client 12 and server 14 may illustrate different modules included in the same computing device.

Server 14 creates and processes project estimates 90 and comprises an electronic computing device operable to receive, transmit, process and store data associated with system 10. For example, server 14 may comprise a general-purpose personal computer (PC), a Macintosh, a workstation, a Unix-based computer, a server computer, or any other suitable device. Server 14 includes a number of modules and memory 20 that are processed by application 16 via processor 28 to support the project estimation activities of system 10. Although FIG. 1 provides one example of a server that may be used with the invention, system 10 can be implemented using computers other than servers, as well as a server pool. Server 14 may include any hardware, software, firmware, or combination thereof operable to process project estimates 90. According to one embodiment, server 14 may comprise a web server. Server 14 can accept a data from client 12 via a web browser (e.g., Microsoft Internet Explorer or Netscape Navigator) and return the appropriate HTML responses through a communication interface 24.

Server 14 also includes communication interface 24 coupled to communication link 22 to support communication between client 12 and the various components of server 14. Interface 24 comprises logic encoded in software and/or hardware in a suitable combination and operable to communicate with link 22. More specifically, interface 24 may comprise software supporting one or more communications protocols associated with link 22 and communications network hardware operable to communicate physical signals associated with link 22.

Memory 20 may include any memory or database module and may take the form of volatile or non-volatile memory including, without limitation, magnetic media, optical media, random access memory (RAM), read-only memory (ROM), removable media, or any other suitable local or remote memory component. In this embodiment, memory 20 includes stored infrastructure project estimates. Memory may include any other data such as, for example, relational database tables or an infrastructure elements table for use by clients 12. Although FIG. 1 illustrates memory 20 as residing internally to server 14, memory 20 may reside externally or at any other location or locations accessible by processor 28. Processor 28 executes instructions and manipulates data to perform the operations of server 14. Although FIG. 1 illustrates a single processor 28 in server 14, multiple processors 28 may be used according to particular needs, and reference to processor 28 is meant to include multiple processors 28 where applicable. In the illustrated embodiment, processor 28 executes the various modules and processes data stored in memory 20.

Server 14 includes numerous project estimation modules 30-80 for receiving input from clients 12, processing project estimates 90, and communicating the results to clients 12. These modules could include any hardware, software, firmware, or combination thereof operable to process project estimates 90 and may be written in any appropriate computer language such as, for example, C, C++, Java, Pascal, and others. It will be understood that while project estimation modules 30-80 are illustrated as separate modules, the features and functionality performed by these engines may be performed by a common module or grouped to multi-tasked modules.

Server 14 includes a command module 30 that generally receives input from client 12 and communicates the resulting project estimate 90 to client 12 via link 26 and interface 24. Command module 30 further coordinates the operations and data flow of the other modules 40-80, via links 81-85, in order to process the received input and produce project estimate 90. Links 81-85 comprise any suitable communication paths between command module 30 and the modules 40-80 of system 10. The example modules utilized by command module 30 to produce a project estimate 90 include identification module 40, loading module 50, assumption identification module 60, estimating module 70, and results module 80.

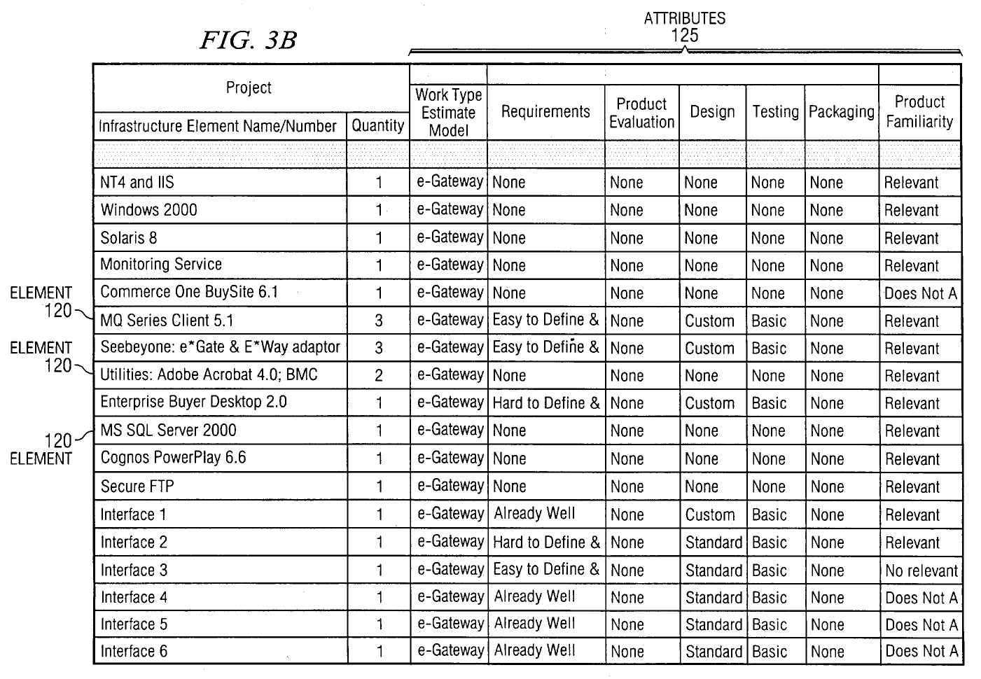

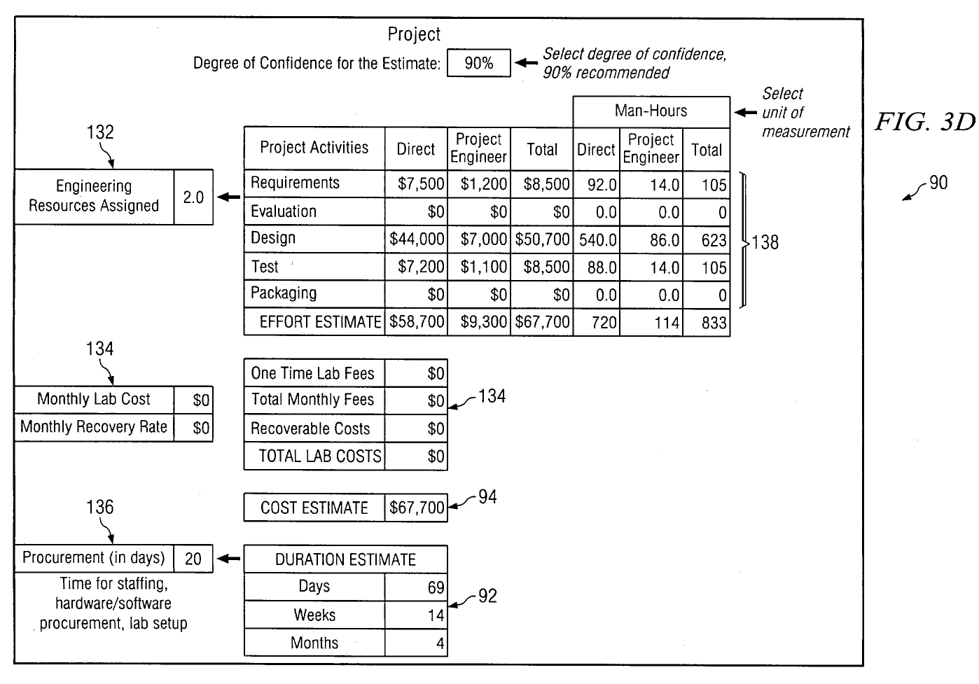

Identification module 40 performs an interactive session with client 12 to identify the various components of a project. These components include infrastructure elements, project name, client requirements, or any other suitable information for describing the project. According to one embodiment, identification module 40 partially comprises a graphing utility that allows client 12 to create a graphical diagram 100 of the various infrastructure elements for the project, illustrated in more detail in FIGS. 5A-5C. Based upon the results of the session, loading module 50 creates a project model of utilized infrastructure elements, illustrated in more detail in FIG. 3B, that is used in later stages of the project estimation process. For example, the project model may comprise a matrix of infrastructure elements and various attributes that may be assigned to each element. The results of the interactive session also provides client 12 the ability to create a list of assumptions, with each assumption linked to one of the selected infrastructure elements, using assumption identification module 60. System 10 uses these assumptions to help determine the size and viability of the project.

Estimating module 70 provides client 12 the ability to specify various attributes for each infrastructure element loaded in the project model. The various attributes may include type of project, level of activity, impact factors, documentation, reusability percentage (based on historical project estimates 90), project management, engineering resources, and lab time and test equipment. In general, estimating module 70 uses these attributes to determine the cost 94 and duration 92 of the project. Client 12 may specify values for the attributes by selecting one or more values from a pull-down list or specifying numeric or percent values. For example, reuse percentage represents the amount of the infrastructure element that does not have to be redesigned and can be used from a prior IT project. Client 12 may specify a numeric value for this attribute. Each selected attribute is normally related to a weighted numeric value of effort that is calibrated by client 12. In one embodiment, an expert for each attribute calibrates, or recalibrates, the numeric values based on recent project experiences with the attribute being used by one or more clients 12. In another embodiment, the calibration is based on historical data. Estimating module 70 may also allow client 12 to specify a level of risk for each assumption identified by assumption identification module 60. Estimating module 70 may use the specified levels of risk to adjust the project cost and duration.

Results module 80 compiles the information in the project model, produced by the other modules 40-70, and produces project estimate 90. Generally, the produced project estimate 90 includes a graphical representation of the project, the duration 92 and cost 94 of the project, and possible variances. Results module 80 may provide a more detailed estimate 90 that includes cost and duration estimates for each infrastructure element. Results module 80 may also store estimate 90 in memory 20 for use by other clients 12 or subsequent project estimation efforts by system 10.

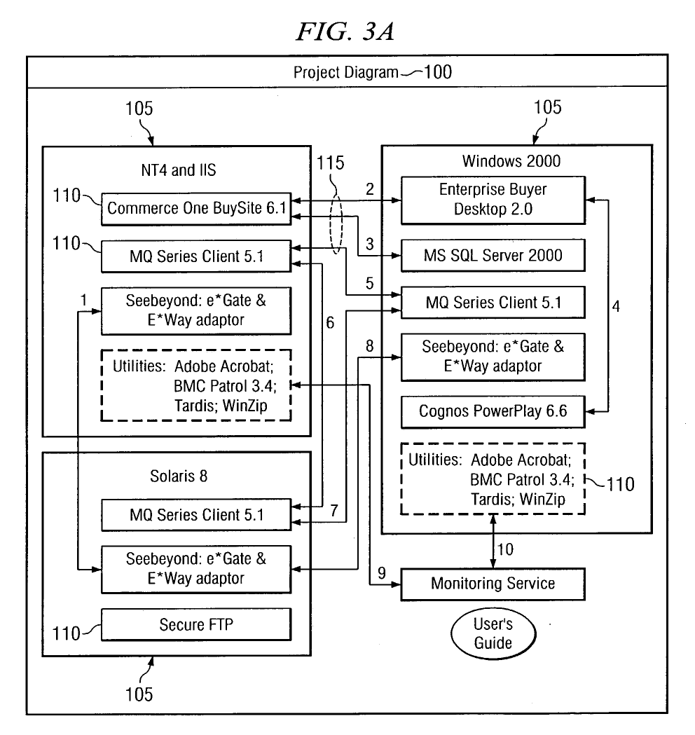

In one aspect of operation, system 10 creates a project estimate 90 based on input from client 12. To communicate the input to server 14, client 12 executes application 16. Once application 16 is executed, command module 30 performs an interactive session with client 12 using a graphical user interface 32 presented to client 12, described in more detail in FIG. 2. Client 12 specifies one or more primary components, or infrastructure elements, of the infrastructure project using identification module 40. Part of this process may include, as described above, defining a graphical project diagram 100 using the defined infrastructure elements. For example, client 12 may specify the boundaries of the project by first defining the operating environments. Next, client 12 may specify the peer software items for each operating environment. Client 12 may then define functional interfaces, or data flows, that exist between the previously defined infrastructure elements.

Once the infrastructure elements have been defined, loading module 50 creates the project model for use through the remainder of the estimating process. For example, loading module 50 may create a matrix of attribute cells for each infrastructure element in the project. The project model may also include a list of assumptions that affect the size and viability of the project. Client 12 may input these assumptions through assumption identification module 60. While each infrastructure element may have more than one assumption, each assumption is linked to one infrastructure element.

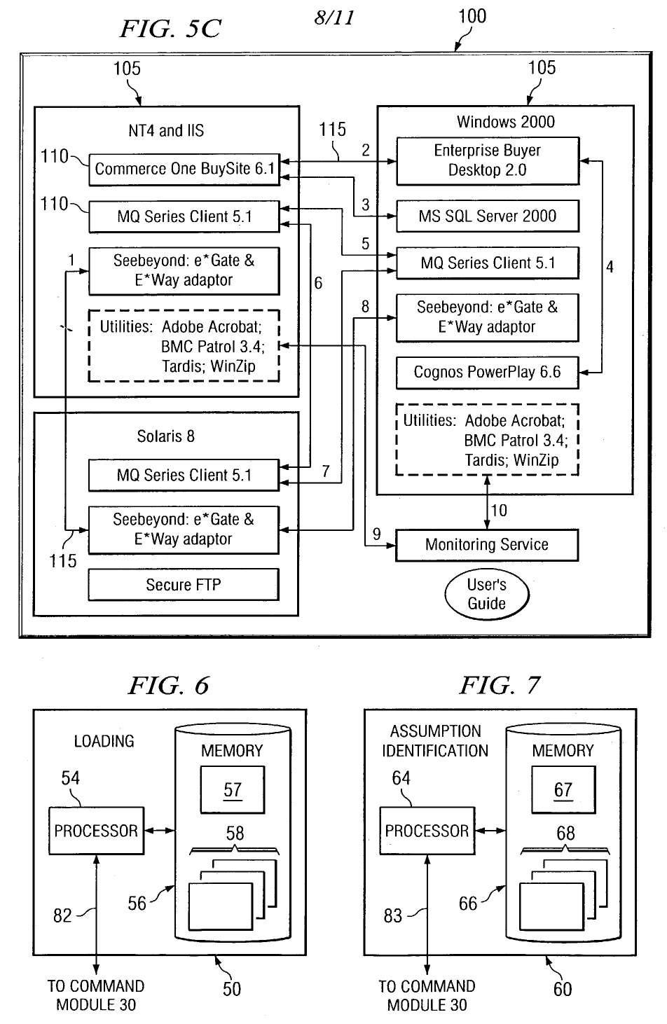

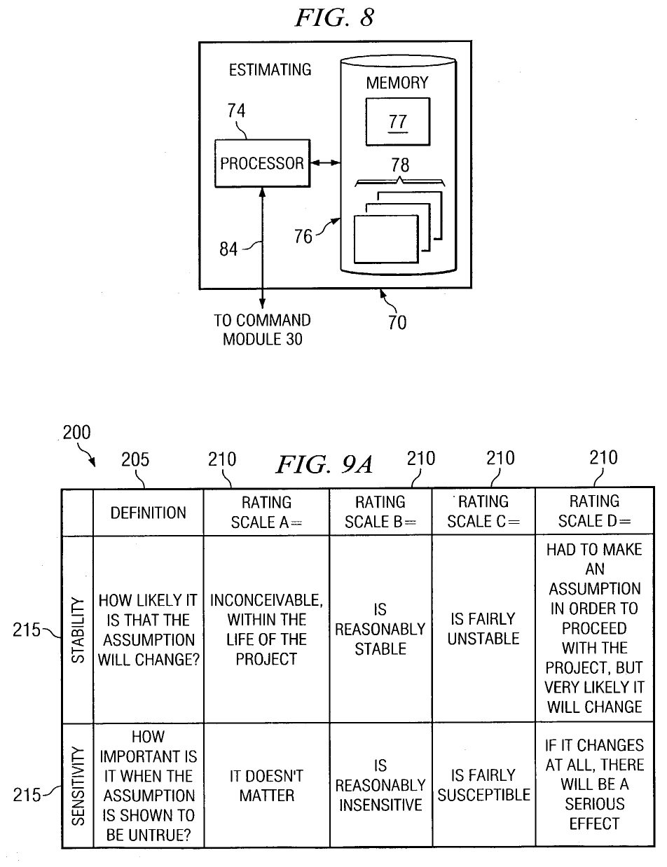

After the project model has been loaded, client 12 specifies the attributes of the infrastructure elements, which affects the cost and duration of the project, through estimating module 70. As described above, client 12 selects various attributes of the identified infrastructure elements through pull-down lists or specifies numeric values. According to a particular embodiment, estimating module 70 may link a weighted numeric value of effort to each attribute. Based on the selected attributes, estimating module 70 processes the project model. For example, estimating module 70 may process the project model on an infrastructure element by element basis as illustrated in more detail in FIG. 8 and FIGS. 9A-9B. Once the project model has been processed, results module 80 compiles the information and produces an infrastructure project estimate 90. As described above, project estimate 90 includes project cost 94, project duration 92 and, a graphical diagram 100 of the project. Server 14 communicates the produced project estimate 90 to client 12. In an alternative embodiment, a first client 12 submits the input for estimation processing by system 10. After processing the input, server 14 communicates project estimate 90 to a second client 12. In other words, the client 12 submitting the input and the client 12 receiving project estimate 90 may be the same or different clients.

FIG. 2 illustrates one embodiment of a command module 30 of the system 10. Module 30 includes a processor 34 coupled to a memory 36 and interface 32. Processor 34 comprises any suitable combination of hardware and software to provide the described function or operation of command module 30. Processor 34 maintains links 81-85 to the various estimation modules 40-80. Links 81-85 comprise any suitable communication paths between the identified components.

Memory 36 comprises any suitable volatile or non-volatile memory device associated with server 14. Memory 36 generally stores a number of files, lists, tables, or any other arrangement of information that supports the administration of sub-modules and project information. For example, memory 36 includes rules 38 and a project estimate table 37. Rules 38 comprise instructions, algorithms, or any other directive used by module 30 to coordinate the processes of, and information sharing between, the estimate modules 40-80. Project estimate table 37 provides a centralized location for the information received from clients 12 and computed by modules 40-80. Accordingly, project estimate table 37 may be separated into multiple tables without departing from the scope of the invention. In general, processor 34 uses the information stored in table 37 to ensure that each module 40-80 possesses the appropriate data for its portion of the estimation process, according to rules 38. Once the processing is complete, processor 34 communicates the results to client 12 through interface 32.

Interface 32 comprises one or more interfaces supported by project estimation application 16 and presented to client 12 using a display. Typically, interface 32 comprises graphical user interfaces (GUIs). GUI 32 facilitates communicating data between users operating clients 12 and server 14 using links 22. GUI 32 may comprise a plurality of displays having interactive fields, pull-down lists, and buttons operated by the user of client 12. It should be understood that the term graphical user interface may be used in the singular or in the plural to describe one or more graphical user interfaces and each of the displays of a particular graphical user interface.

FIGS. 3A-3D illustrate exemplary displays of graphical user interface 32 supported by system 10. FIG. 3A illustrates one display of GUI 32 that provides an interactive graphing tool to create the graphical project diagram 100 and the component infrastructure elements. This display communicates with identification module 40 to ensure that consistent infrastructure elements are used between a plurality of projects. In this particular embodiment, the graphical project diagram 100 includes operating environments 105, software 110, and functional interfaces 115.

FIG. 3B illustrates one example display of GUI 32 that provides a portion of the project model for client 12 to input the relevant information for the project such that system 10 can provide project estimate 90 based on the input data. This embodiment of the display allows client 12 to enter the infrastructure elements 120 through loading module 50 and to specify the attributes 125 for each infrastructure element through estimating module 70. According to particular embodiments, each infrastructure element 120 is listed once with a quantity determined by the graphical project diagram 100 to allow for more efficient processing. For example, servers 105, software 110, and interfaces 115 are each defined as one element 120 in the project model. These elements 120 and related attributes 125 are used by system 10 to calculate the project cost 94 and duration 92.

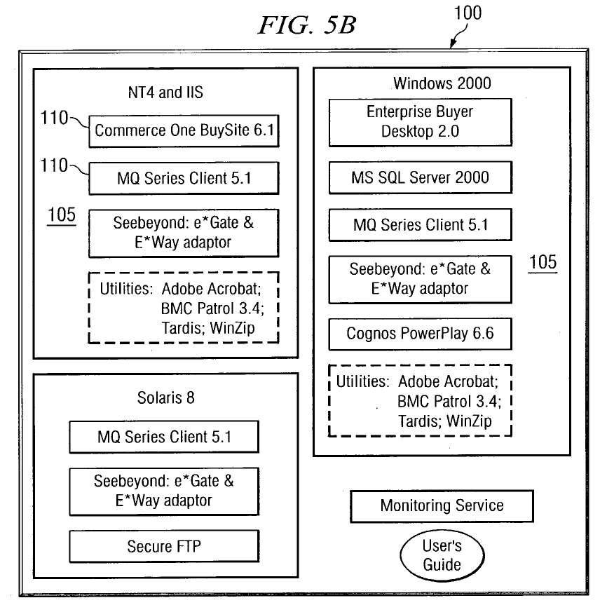

FIG. 3C illustrates one display of GUI 32 that provides a portion of the project model for client 12 to enter the project assumptions 130 for assumption identification module 60. In this embodiment, assumptions 130 are divided into two primary categories: assumptions 130 that affect project size and assumptions 130 that affect project viability (described in more detail in FIG. 7). Each assumption 130, regardless of category, is linked to one infrastructure element 120.

FIG. 3D illustrates one display of GUI 32 that provides the results of project estimate 90 from results module 80. In this embodiment, the display includes the number of engineer resources assigned to the project 132, lab costs and testing fees 134, procurement time 136, the cost and duration of each major phase of the project 138, and the final cost 94 and duration 92. The exemplary display further includes an interactive selection that allows client 12 to view the estimate details for each infrastructure element.

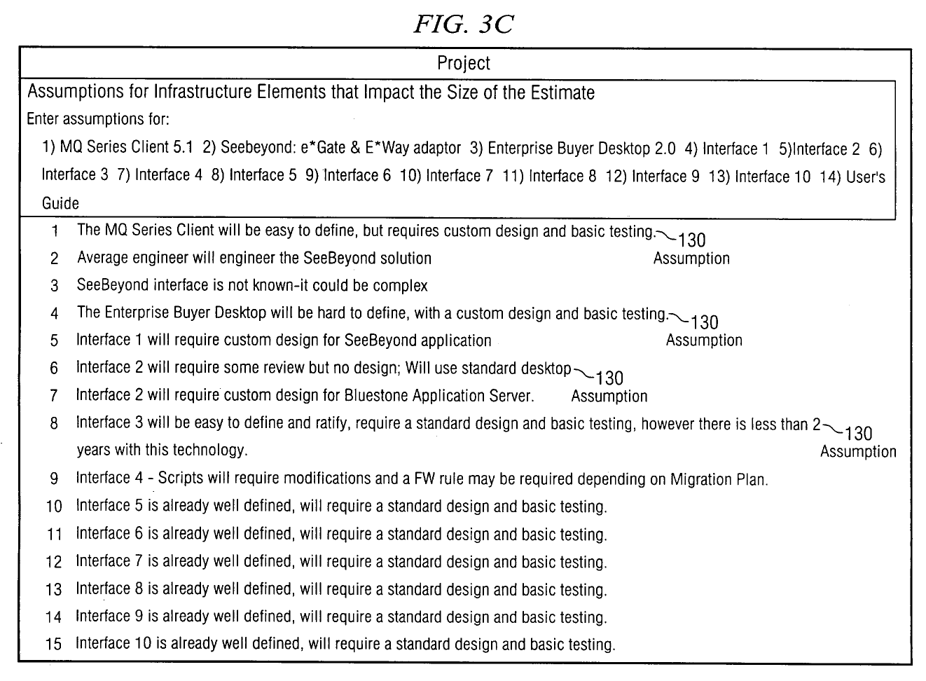

FIG. 4 illustrates one embodiment of an identification module 40 of system 10. Module 40 includes a processor 44 coupled to a memory 46. Processor 44 comprises any suitable combination of hardware and software to provide the described function or operation of identification module 40. Processor 44 maintains a link 81 to command module 30. Link 81 comprises any suitable communication path between the identified components.

Memory 46 comprises any suitable volatile or non-volatile memory device associated with server 14. Memory 46 generally stores a number of files, lists, tables, or any other arrangement of information that supports the identification of infrastructure elements by client 12. For example, memory 46 includes rules 48 and an infrastructure elements table 47. Rules 48 comprise instructions, algorithms, or any other directive used by module 40 to select or diagram particular infrastructure elements. Infrastructure elements table 47 may include graphical representations of infrastructure elements selected by client 12 for display in GUI 32. Accordingly, infrastructure elements table 47 may be separated into multiple tables without departing from the scope of the invention. As described in FIG. 1, infrastructure elements may include operating environments, hardware, software, interfaces, services, documentation, and other suitable components. In one embodiment, operating environments are a combination of hardware, operating system software and firmware, documentation, and add-on software, interfaces are data flow paths, services are IT efforts that are in addition to those needed for the completion of the project, and documentation is any optional documentation that is not normally produced as a project deliverable. In general, processor 44 uses the information stored in table 47 to create a graphical representation 100, as illustrated in FIGS. 5A-5C, based on input from client 12. Processor 44 communicates the selected appropriate infrastructure elements to command module 30 for processing and display via link 81.

In one aspect of operation, there are three phases in selecting the appropriate infrastructure elements: identifying operating environments, identifying software items, and identifying functional interfaces. It will be understood that these phases are exemplary and any appropriate technique may be used to select the infrastructure elements. The first example phase, identifying operating environments, comprises client 12 selecting appropriate operating environments, illustrated in FIG. 5A. Operating environments are generally defined as hardware, operating system software (including firmware), documentation, and add-on software components that enable other types of software to deliver their respective functionality. According to particular embodiments, system 10 may impose certain rules 48 on client 12 for identifying the operating environments and supplementing graphical project diagram 100 such as, for example:

1) Indicate and label each unique operating environment needed to satisfy the specified or implied project requirements.

2) Indicate as much detail for the operating environment as needed to make management level decisions regarding familiarity or unique aspects of the operating environment.

The second phase, identifying peer software items, comprises client 12 identifying functional software elements beyond operating system software. By identifying a software item within an operating environment, client 12 is implying that an interface infrastructure element exists between the two infrastructure elements (the operating environemnt infrastructure element and the software infrastructure element). As above, system 10 may impose certain rules 48 on client 12 for identifying the software items including, for example:

1) Significant pieces of software should be defined as residing within the boundaries of its operating environment.

2) In the event of an interface between software and a hardware device, operating system, or micro-code without intervening software, define the hardware function, operating system service, or micro-code function as a software element.

3) A single software element with no interfaces to other software elements can be added to an environment to indicate utilities, such as management components, that may represent significant engineering effort.

The third phase of identifying infrastructure elements, identifying functional interfaces (or data flows), comprises client 12 identifying interfaces (or data flows) between two infrastructure elements. For example, if an interface exists between two operating environments, then there are three infrastructure elements (two operating environments and one functional interface). As described above, by identifying a software item within an operating environment, client 12 is implying that an interface infrastructure element exists between the two infrastructure elements (the operating environment infrastructure element and the software infrastructure element). As above, system 10 may impose certain rules 48 on client 12 for identifying the interfaces including, for example:

1) Indicate all interfaces with a double-headed arrow.

2) Include all interfaces that involve the transfer of data, even if no engineering effort is required.

3) One arrow represents all interfaces between two software elements. For example, an integrated portal could interface to a directory for authentication, personalization, and to retrieve user information. There should still be only one interface arrow between the portal software and the directory software.

4) Arrows should point to objects on the diagram. In this way implied work effort from other work types/functional areas are incorporated into the project model.

5) Interfaces should not point to optional documents when the documents are indicated in the project diagram.

FIGS. 5A-5C illustrate a graphical project diagram 100 of infrastructure elements in accordance with system 10. According to particular embodiments, system 10 may include unique graphical symbols for each type of infrastructure element. For example, an operating environment may be symbolized by a double-lined box, software by a single-lined box, interfaces by a double-ended arrow, services by a bolded box, and documentation by a circle. FIG. 5A illustrates the graphical representation of the operating environments, as defined in FIG. 4, in graphical project diagram 100. As described above, the various operating environments 105 include hardware, operating system software and firmware, and documentation elements. The illustrated embodiment includes NT with IIS, Windows 2000, and Sun Solaris. Also included are a monitoring service and a user's guide document. It will be understood that any appropriate operating environment 105 may be defined or selected.

FIG. 59 illustrates graphical project diagram 100 further including the software items 110, as defined in FIG. 4. As described above, the software items are defined for each operating environment. In this illustrated embodiment, the NT4 and IIS operating environment includes Commerce One Buysite 6.1, MQ Series 5.1, Seebeyond, and various utilities, the Windows 2000 environment includes Buyer Desktop 2.0, MS SQL Server 2000, MQ Series 5.1, Seebeyond, Powerplay 6.6, and various utilities, and the Solaris operating environment includes MQ Series 5.1, Seebeyond, and Secure FTP. It will be understood that any appropriate software items 110 may be defined or selected.

FIG. 5C illustrates the graphical representation 100 further including the functional interfaces 115, as defined in FIG. 4. As described above, functional interfaces 115 represent data being transferred between two software elements. In this illustrated embodiment, there are ten functional interfaces 115 between various software elements. It will be understood that any appropriate functional interface 115 that represents data flow may be defined or selected.

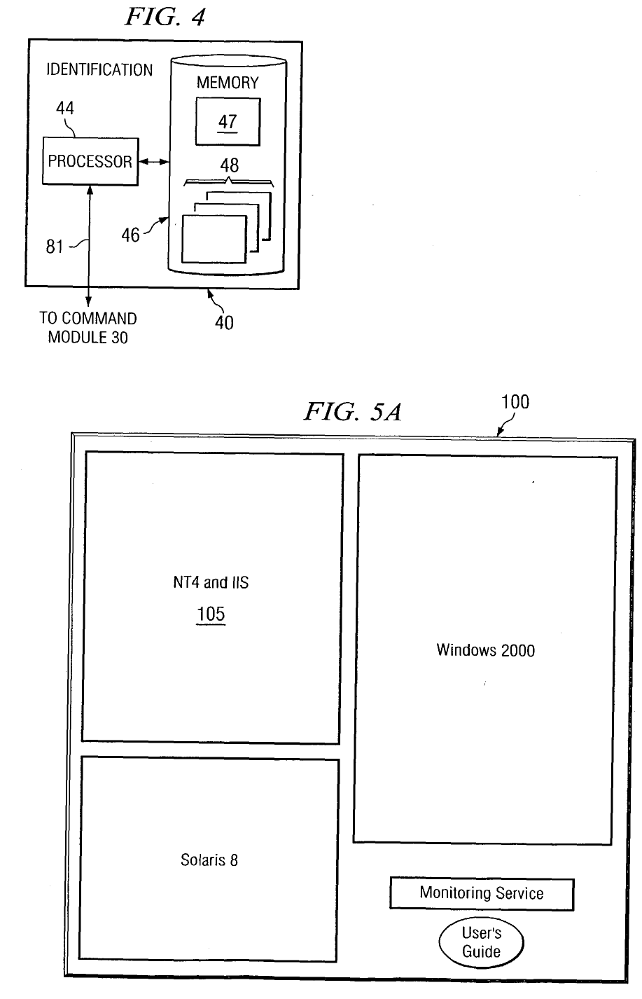

FIG. 6 illustrates one embodiment of a loading module 50 of system 10. Module 50 includes a processor 54 coupled to a memory 56. In general, loading module 50 loads the infrastructure elements identified by identification module 40 into a project model. Processor 54 comprises any suitable combination of hardware and software to provide the described function or operation of identification module 50. Processor 54 maintains a link 82 to command module 30. Link 82 comprises any suitable communication path between the identified components.

Memory 56 comprises any suitable volatile or non-volatile memory device associated with server 14. Memory 56 generally stores a number of files, lists, tables, or any other arrangement of information that supports the loading of the identified infrastructure elements into a project model. For example, memory 56 includes rules 58 and a project model table 57. Rules 58 comprise instructions, algorithms, or any other directive used by module 50 to load one project model stored in project estimation model table 57. Accordingly, project model table 57 may be separated into multiple tables without departing from the scope of the invention. Project estimation model table 57 includes information associated with the project model. In general, processor 54 uses the information from identification module 40 to load the project model, according to rules 58. For example, rules 58 may include:

1) Infrastructure elements can be loaded in any order in the project model. For example, one approach is to enter the operating environments, followed by the software, services, and interface elements.

2) There should be one row in the project model for each unique description on the project diagram 100.

3) When an infrastructure element with the same description appears multiple times in the project diagram 100, register the infrastructure element once and enter the quantity of occurrences.

4) Register each of the interface elements as infrastructure elements in the project model using the word “interface” as a prefix for the number label from the diagram.

Processor 54 communicates the loaded project model to command module 30 using link 82.

FIG. 7 illustrates one embodiment of an assumption identification module 60 of system 10. Module 60 includes a processor 64 coupled to a memory 66. Processor 64 comprises any suitable combination of hardware and software to provide the described function or operation of assumption identification module 60. Processor 64 maintains a link 83 to command module 30. Link 83 comprises any suitable communication path between the identified components.

Memory 66 comprises any suitable volatile or non-volatile memory device associated with server 14. Memory 66 generally stores a number of files, lists, tables, or any other arrangement of information that supports the identification of assumptions by client 12. For example, memory 66 includes rules 68 and an assumptions table 67. Rules 68 comprise instructions, algorithms, or any other directive used by module 60 to select particular assumptions. Assumptions table 67 includes information associated with the infrastructure elements retrieved by the loading module 50 and stored in the project model. Accordingly, assumptions table 67 may be separated into multiple tables without departing from the scope of the invention. In general, processor 64 uses the information stored in table 67 to create a list of assumptions in the project model according to rules 68 (as illustrated in FIG. 3C). Processor 64 communicates the defined assumptions to command module 30 using link 83.

The infrastructure elements in a project can be separated into two groups: elements with effort and elements with no effort. Infrastructure elements with effort contribute to the size and viability of the final estimate. The assumptions for these infrastructure elements define the scope of the effort. The second group of infrastructure elements, those with no associated effort, defines the viability of the estimate. In other words, the project cannot be completed with the estimated effort unless the assumptions for these elements are true. Each infrastructure element can have more than one assumption linked to it, but the element must have at least one assumption.

FIG. 8 illustrates one embodiment of an estimating module 70 of system 10. Module 70 includes a processor 74 coupled to a memory 76. Processor 74 comprises any suitable combination of hardware and software to provide the described function or operation of identification module 70. Processor 74 maintains a link 84 to command module 30. Link 84 comprises any suitable communication path between the identified components.

Memory 76 comprises any suitable volatile or non-volatile memory device associated with server 14. Memory 76 generally stores a number of files, lists, tables, or any other arrangement of information that supports the identification of infrastructure elements by client 12. For example, memory 76 includes rules 78 and a selections table 77. Rules 78 comprise instructions, algorithms, or any other directive used by module 70 to quantify the selections of client 12 to process the estimate for each infrastructure element and the project. Selections table 77 includes information associated with a plurality of attributes for various infrastructure elements. Accordingly, selections table 77 may be separated into multiple tables without departing from the scope of the invention. In general, processor 74 uses the information stored in table 77 to present appropriate attribute options for client 12 to select in the project model through interface 32, according to rules 78.

For example, selections table 77 may store work types, activity types, levels of effort, impact factors, and any other suitable attribute. In this example embodiment, work type selections may include web-services, security, permissions management, networking, and any other appropriate business unit or project element type. Each element has one or more activity attributes including requirements, element evaluation, design, testing, and packaging. Selecting the required activities for each infrastructure element in a project is one primary contributor to the estimate 90 for the project. Example level-of-effort options for the example activities are described below:

Requirements

1. None—No effort is needed for this infrastructure element. Requirements are understood, validated and approved.

2. Already Well Defined—Requirements are written, understood and validated, but need final approval.

3. Easy To Define & Ratify—Requirements are written and understood, but need to be validated and approved.

4. Hard To Define & Ratify—Requirements are unwritten or unclear for this infrastructure element.

Element Evaluation

1. None—No element evaluation effort for this infrastructure element.

2. Paper, Most Respected Elements—An evaluation report is required involving elements well regarded for the function.

3. Paper, Comprehensive—An evaluation report is required involving a broad review of elements for the function.

Design

1. None—No design effort is needed for this infrastructure element.

2. Standard Design—The design based on an established practice, but no formal template.

3. Custom Design—The design is not based on an established practice or template.

4. Template—non-primary technology—The design is for an infrastructure element based on an existing formal template.

5. Template—non-technology template—The design is based on an existing formal template that delivers a non-technology service.

6. Template—primary technology—The design is for an infrastructure element crucial to the customer solution and based on an existing formal template.

Test

1. None—No testing is required for this infrastructure element.

2. Basic—Functional testing is required.

3. Performance and Stress testing—Functional testing and non-application performance testing is required.

Package

1. None—No packaging effort is required for this infrastructure element.

2. Document preparation—Document preparation is required.

3. Media preparation—Media preparation is required.

4. Document and Media—Both document and media preparation are required.

Each infrastructure element may also include impact factor attributes for various work types. Four example factors are element familiarity, element maturity, element complexity, and project stability. Example selection options for the example impact factors are described below:

Element Familiarity

1. Does Not Apply—Not a factor for this element.

2. Relevant experience in the last 6 months

3. Relevant experience in the last 12 months

4. Relevant experience in the last 18 months

5. No relevant experience

Element Maturity

1. Does Not Apply—Not a factor for this element.

2. New Minor Version—This element has been in the field at least one year, but this is a new point release.

3. New Major Version—This element has been in the field at least one year, but this is a major new version.

4. New product—This is an early adoption of new technology

5. Leading Edge Technology—This is an early adoption of new technology

6. Unstable—This is beta and unstable

Element Complexity

1. Does Not Apply—It is not complex

2. Has GUI and few controls—There is a navigating interface and few control parameters

3. No GUI or many controls—There is no navigating interface and few control parameters

4. No GUI and many controls—There are more than 40 control parameters and only line commands to control the element

Project Stability

1. Does Not Apply—Stability is not an issue for this infrastructure element

2. Clear roles and responsibility—Roles and responsibilities are clearly defined

3. Ambiguous roles and responsibility—Roles and responsibilities are not defined

4. Charged environment—It is questionable as to who will be the source of requirements

Rules 78 may assign one or more weighted numeric values to each selection option. The numeric values may correspond to days-of-effort or cost. It should be understood that each element activity (requirements, design, testing, etc.) will require its own calculation for level of activity to deliver the desired result of the activity. It should also be understood that the level of effort is normally not estimated as an absolute value. Therefore, each level of effort is processed as a range of values, indicating a probability that the effort will be a predicted value. The most likely value has the highest probability in the range of values. The high and low values represent the extremes of the distribution of values. For example, the “test” element activity may have three levels of work effort, each with three associated numeric values, for a particular work type:

| | | Man-Days of Effort | | |
|---|---|---|---|---|
| Level of | | | Most | |
| Test | Required Work | Low | Likely | High |
| 1 | No testing required | 0 | 0 | 0 |
| 2 | Basic functional testing | 2 | 5 | 7 |
| 3 | Basic functional testing | 6 | 10 | 15 |
| | plus performance/stress | | | |
| | testing | | | |

Rules 78 may also associate multiple values corresponding to discrete levels of effect from each impact factor. For example, the “product familiarity” impact factor has four levels for a particular work type:

| Impact | | |
|---|---|---|
| Factor | Criteria | |
| Product | 1. | Yes, relevant experience in the last |
| Familiarity | | 6 months |
| | 2. | Yes, relevant experience in the last |
| | | 12 months |
| | 3. | Yes, relevant experience in the last |
| | | 18 months |
| | 4. | No previous knowledge |

Estimating module 70 associates each criterion with a value that is expressed as:

1±x %

where “x” is a value from 0 to 100 percent. Returning to the example, “product familiarity”—criterion 1 could have a value of 0.90 (1-10%), meaning that the effort for all project activities for the infrastructure element will be reduced by 10% due to familiarity with the components involved.

Rules 78 may also regulate the options of one or more attributes based on the selection of other attributes. For example, the options for levels of effort and impact factors, available to client 12, may be determined by the work type attribute selected by client 12. Once client 12 selects the appropriate attributes for each infrastructure element, processor 74 communicates the selected attributes to command module 30 using link 84 for storage in the project model.

In one aspect of operation, estimating module 70 uses the project model to process each infrastructure element to compute a cost and duration based on the selected attributes, according to rules 78. For example, estimating module 70 may total all of the levels of effort per infrastructure element. The result of totaling the efforts for a particular infrastructure element across its activities may be a distribution, with a “most likely”, a “high”, and a “low” value. The total effort is then modified by the impact factors. The effect of the impact factors is cumulative, meaning that the presence of two factors together has a greater effect than either one alone on the element effort. Totaling all the efforts across all infrastructure elements will, therefore, result in the effort for the project given as a distribution: a “most likely”, a “high” and “low” value. This effort is used by estimating module 70 to compute the duration 92 estimate. Estimating module 70 may perform other calculations, as appropriate, to determine the cost and duration for each element and the entire project. For example, a plurality of example estimating formulas for use by estimating module 70 for computing the cost 94 and duration 92 of project estimate 90 are illustrated below. The formulas are for illustration purposes only. It will be understood that any appropriate calculations may be performed by system 10 to compute the duration 92 and cost 94 of the IT project. According to particular embodiments, estimating module 70 may first compute an estimate of the engineering effort, which may be illustrated as:

$${\sum }_{i = 1}^{{Elements}^{Infrastructure}} ( {ImpactFactor}_{i} {XEffort}_{i} ) = EffortEstimate \pm {Δ}_{E}$$

where the impact factor is the product of the impact factor attributes described above and the effort is the sum of all of the levels of effort for the activity attributes. In other words, for each infrastructure element, estimating module 70 may:

Multiply the element impact factor attributes together to form an impact factor for the infrastructure element

Total the values for the activity attributes to form various probabilities of the effort for the infrastructure element (low, most likely, high)

Multiply each effort value by each impact risk factor to form the infrastructure element estimate

Estimating module 70 then totals the infrastructure element efforts for all of the infrastructure elements in the project to form a project effort estimate. Estimates for project management are added to the project effort estimate based on the estimated staffing and duration of the project due to the identified assumptions.

After the project effort is determined, estimating module 70 derives an estimate of the project duration 92 based on the project effort estimate. The duration 92 estimate may also be based on:

an estimate of the engineering resources assigned to the project.

non-parallel procurement activities such as hardware procurement, lab setup, test scheduling and model office availability.

Accordingly, the estimate of project duration 92 can be expressed as:

Duration=(project effort estimate/engineering resources)+procurement

In one embodiment, the duration estimate 92 is in days as the effort estimate is in days. The average number of workdays per month is 22.7 as calculated below:

52 weeks×5 days per week/12 months=22.7 average days per month

Therefore, the duration of the project in months may be computed by dividing the duration by 22.7:

Duration estimate/22.7

Project estimate 90 also includes a project cost 94. Estimating module 70 computes cost 94, which may include component costs such as, for example, resource costs, one-time and monthly lab fees, hardware and software expenses, and any other appropriate financial value that can be applied to the elements or project.

Estimating module 70 may also modify the cost 94 based on the level of project management. As described in FIG. 8, project management may be defined on an element-by-element basis and/or a global project management basis. The project cost 94 is modified by the project management, normally through adding the project management estimate to the cost estimate 94 to achieve a final cost estimate 94.

As described above, the level of resource needed to do the work of the project is specified for each infrastructure element. For example purposes only, the resource level is entered as a percentage of a Level 1, Level 2, or Level 3 resource, with the level indicating the relative expertise of the resource. The total of the percentages should be 100%. The type of rate to use for the resources may be selected. In one embodiment, the rates could be selected as internal or external. It should be understood that any resources and resource rate structure may be used. The rate for the infrastructure element becomes a blended rate that can be expressed as:

Level 1 Rate Rate Type X Level 1%+

Level 2 Rate Rate Type X Level 2%+

Level 3 Rate Rate Type X Level 3%

A resource rate is computed as a weighted average of the blended rates of the plurality of infrastructure elements in the project. For example,

$${\sum }_{i = 1}^{{Elements}^{Infrastructure}} ( {BlendedRate}_{i} {XEffort}_{i} ) / EffortEstimate = ResourceRate$$

Estimating module 70 applies the resource rate to both the engineering and project management efforts to determine the total cost of effort for the project. Estimating module 70 may assume the resource rate is a monthly rate.

Estimating module 70 may also calculate one-time and monthly lab costs, as illustrated below:

$${\sum }_{i = 1}^{{Elements}^{Infrastrure}} One - {TimeLabRate}_{i} X {£}_{IE} = One - TimeLabFee Estimate$$

where #_{IE} is the number of the particular infrastructure

$${\sum }_{i = 1}^{{Elements}^{Infrastrure}}$$

Monthly Lab Rateᵢ×#_{IE}×(Effort Estimate/#resources/22.7=Monthly Lab Fee Estimate

elements and 22.7 is the average number of workdays per month, computed above. The monthly lab cost estimate is derived from the effort estimate. The effort estimate is used to calculate how much time (effort estimate/engineering resources) a project lab could be used during the project. In one embodiment, estimating module 70 uses the effort estimate instead of the duration 92 because duration 92 includes the procurement time for the equipment and lab set up. The project model allows for both monthly and one-time lab charges for each infrastructure element. The charges are multiplied by the quantity of the infrastructure element for which they are specified by client 12.

Estimating module 70 may also calculate the hardware/software expenses for the project. It may be computed by the following formula:

$${\sum }_{i = 1}^{{Elements}^{Infrastructure}}$$

((Equipment Rateᵢ×Effort Estimate)/#resources)/22.7=Equipment Cost Estimate

This example formula illustrates that the equipment cost estimate is a sum of all the equipment rates for all infrastructure elements for the duration of equipment use, where 22.7 is the average number of workdays per month. Once the appropriate component costs have been determined, estimating module 70 processes the component costs to determine the total cost 94. Cost 94 may be calculated and/or displayed on an element-by-element basis or overall.

FIGS. 9A-9B illustrate operation of an ABCD matrix for risk assessment for use by estimating module 70. FIG. 9A illustrates a rating scale 200 for characteristics 215 “stability” and “sensitivity” of each assumption as defined in FIG. 7. The exemplary rating scale ranges from ratings 210 “A” through “D” for both “stability” and “sensitivity”. For example, the assumption characteristics 215 “stability” is defined as the likelihood of change of the assumption and “sensitivity” is defined as the importance of the assumption to the project. Each assumption is ranked 215 either “A”, “B”, “C”, or “D” for each of these characteristics.

Based on the rankings 215 for each characteristic 210, the assumption can be mapped onto ABCD matrix 250, illustrated in FIG. 9B. Matrix 250 includes 2 axes, stability 255 and sensitivity 260. Each axis includes four rankings “A” through “D”, which creates sixteen cells. Each cell is in one of three categories: acceptable risk 265, questionable risk 270, and unacceptable risk 275. System 10 allows for the stability ranking 210 to be mapped to the stability axis 255 and sensitivity ranking 210 to be mapped to the sensitivity axis 260. This results in the assumption risk being located in a cell of matrix 250. Based on the category of the resulting cell, system 10 ranks the assumptions by level of risk. For example, if an assumption is ranked “B” for stability and “A” for sensitivity, then the assumption has no or an acceptable level of risk. Based on the risk level, system 10 may add the cost and effort for risk management or risk mitigation to the project totals.

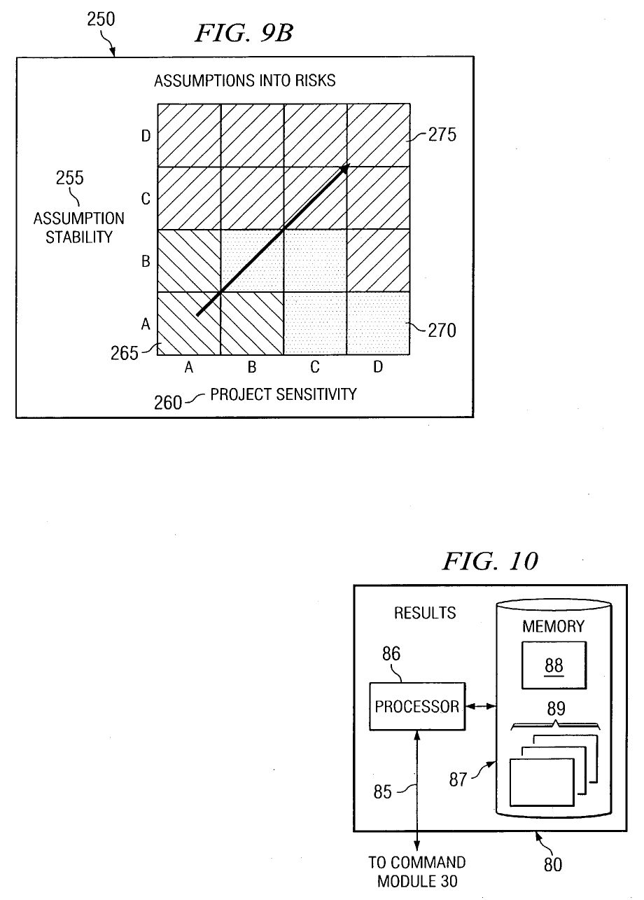

FIG. 10 illustrates one embodiment of a results module 80 of system 10. Module 80 includes a processor 86 coupled to a memory 87. Processor 86 comprises any suitable combination of hardware and software to provide the described function or operation of identification module 80. Processor 86 maintains a link 85 to command module 30. Link 85 comprises any suitable communication path between the identified components.

Memory 87 comprises any suitable volatile or non-volatile memory device associated with server 14. Memory 87 generally stores a number of files, lists, tables, or any other arrangement of information that supports the presentation of project estimate 90 to client 12. For example, memory 87 includes rules 89 and a results table 88. Rules 89 comprise instructions, algorithms, or any other directive used by module 80 to compile and sort the components of estimate 90. Results table 88 includes information associated with estimate module 70 based on data from the project model. Accordingly, results table 88 may be separated into multiple tables without departing from the scope of the invention. In general, processor 86 uses the information stored in table 88 to present project detail and summary of duration 92 and cost 94 information to client 12, according to rules 89. Processor 86 communicates the results to command module 30, for presentation to client 12, using link 85.

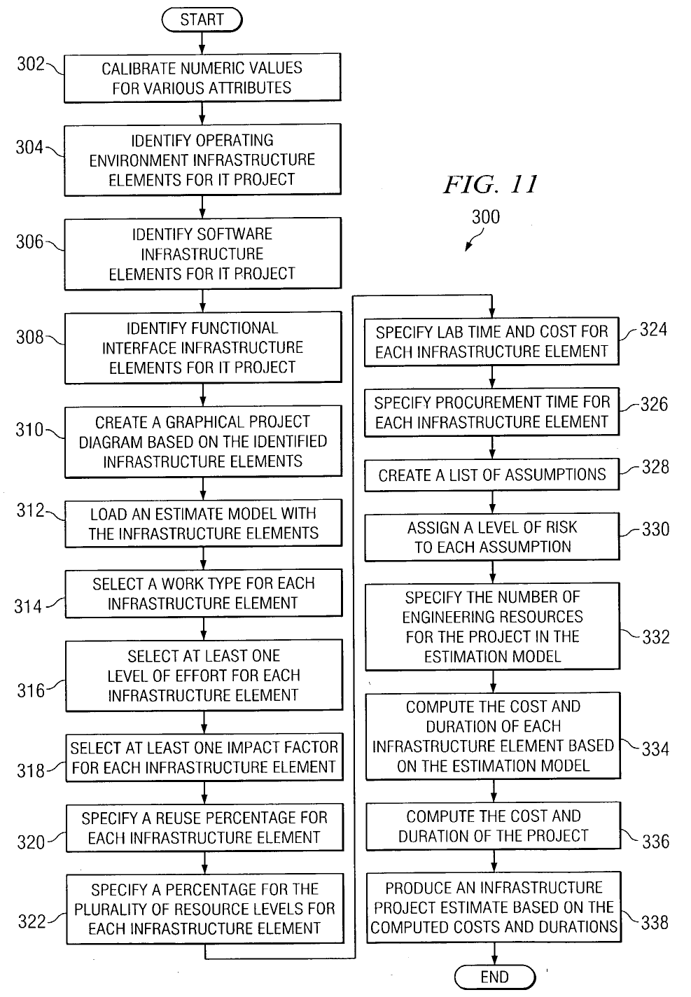

FIG. 11 illustrates a flow chart of an exemplary method 300 for producing infrastructure project estimate 90 for information technology. Method 300 is described in respect to system 10. However, any other suitable system may use method 300 to produce an infrastructure project estimate 90 without departing from the scope of this disclosure. Generally, method 300 describes the initialization, or calibration, of a project model, the loading of the project model, and the production of an infrastructure project estimate 90 based on the project model.

Generally, system 10 produces project estimate 90 based on infrastructure elements defined for the IT project and the attributes assigned to those infrastructure elements in the project model. Weighted numeric values for these attributes are calibrated at step 302. In one embodiment, an expert using client 12 assigns the numeric values for each option of the attributes based on prior experience with similar IT projects. Once the attributes are appropriately calibrated, client 12 defines the scope of the project in steps 304 through 310 using identification module 40. At step 304, client 12 identifies operating environments and infrastructure elements for the IT project, such as, for example, hardware and operating systems. At step 306, client 12 identifies software infrastructure elements for the IT project for each operating environment defined in step 304. Client 12 then identifies functional interface infrastructure elements at step 308. As described in FIG. 1, functional interfaces generally include data flows between other infrastructure elements. At step 310, client 12 creates a graphical project diagram 100 based on the identified infrastructure elements from steps 304 through 308. After the elements have been defined for the project, attributes for the various elements are specified in steps 312 through 326 using estimating module 70 as illustrated in FIG. 3C.

At step 312, loading module 50 loads a project model with the infrastructure elements specified in steps 304 through 308. Next, at step 314, client 12 selects a work type for each infrastructure element loaded into the project model. For example, client 12 may select security or e-commerce as a work type. Client 12 then selects at least one activity for each infrastructure element at step 316. Client 12 may choose to select no activities for an infrastructure element. Such elements are included for assumptions and to document that the infrastructure element was included in the considerations for the project estimate. At step 318, client 12 selects at least one impact factor for each infrastructure element. Client 12 may choose to indicate that no impact factors apply to a particular infrastructure element. At step 320, client 12 specifies a reuse percentage for each infrastructure element. As described in more detail in FIG. 1, reuse percentage represents the amount of the infrastructure element that does not have to be redesigned and can be used from a prior IT project. Next, client 12 specifies a percentage for each resource level for each infrastructure element at step 322. At step 324, client 12 specifies the lab time and cost for each infrastructure element. At step 326, client 12 specifies the procurement time, in days, for each infrastructure element. In one embodiment, the procurement time is specified at the project level without the need to consider each element. It should be understood that any other appropriate attributes, such as project management, may be associated with an infrastructure element.

As well as element attributes, system 10 may also calculate the scope and viability of the project using assumptions and number of resources. Using assumption identification module 60, client 12 creates a list of assumptions at step 328. In one embodiment, system 10 requires at least one assumption for every infrastructure element. Next, at step 330, client 12 assigns a level of risk to each assumption in the list. At step 332, client 12 uses estimating module 70 to specify the number of engineering resources for the project in the project model. As described above, each engineering resource may represent more than one engineer working part time on the project. The assignment of full or part-time engineering resources will depend on the availability and skill of the resources.

Using all of the input information from the interactive session with client 12, estimating module 70 computes the cost and duration of each infrastructure element based on the project model, as described in more detail in FIGS. 9A through 9E. Also, at step 336, estimating module computes the cost 94 and duration 92 of the entire project. In one example, estimating module 70 merely sums the cost and duration of each infrastructure element to compute the total cost and duration of the project. In another example, estimating module 70 separately computes the cost and duration of the project. This second example may be used when the cost and/or duration of multiple infrastructure elements may overlap. Once estimating module 70 has computed the cost and duration of the project and each infrastructure element, results module 80 produces an infrastructure project estimate 90 based on the computed costs 94 and durations 92. According to particular embodiments, command module 30 communicates the infrastructure project estimate 90 to client 12.

The preceding flowchart and accompanying description illustration only an exemplary method 300 for server 14 to produce an infrastructure project estimate 90. However, system 10 contemplates server 14 using any suitable technique for performing these tasks. Thus, many of the steps in this flowchart may take place simultaneously and/or in different orders than as shown. Moreover, server 14 may use methods with additional steps, fewer steps, and/or different steps, so long as the methods remain appropriate.

Although the present invention has been described in detail, it should be understood that various changes, substitutions and alterations can be made hereto without departing from the sphere and scope of the invention as defined by the appended claims.

To aid the Patent Office, and any readers of any patent issued on this application in interpreting the claims appended hereto, applicants wish to note that they do not intend any of the appended claims to invoke ¶ 6 of 35 U.S.C. § 112 as it exists on the date of filing hereof unless “means for” or “step for” are used in the particular claim.

What is claimed is:

1. A method for producing an infrastructure project estimate comprising:
identifying a plurality of infrastructure elements, the infrastructure elements comprising operating environments, software, interfaces, service, and documentation;
loading a project model with the plurality of infrastructure elements;
selecting at least one attribute for each infrastructure element in the project model;
processing at least a portion of the project model based on each selected attribute; and
producing an infrastructure project estimate based on the processed project model, the estimate comprising project cost and project duration.

2. The method of claim 1, wherein identifying a plurality of infrastructure elements comprises:
identifying operating environments;
identifying peer software items; and
identifying functional interfaces.

3. The method of claim 2, further comprising creating a graphical project diagram based at least in part on the identified infrastructure elements.

4. The method of claim 3, wherein identifying operating environments comprises diagramming each unique operating environment, each operating environment comprising hardware, operating system software, documentation, add-on software.

5. The method of claim 3, wherein identifying peer software items comprises diagramming each software item within one operating environment.

6. The method of claim 3, wherein identifying functional interfaces comprises diagramming one interface to represent the one or more functional interfaces between elements.

7. The method of claim 1, further comprising:
creating a plurality of assumptions, each assumption linked to an infrastructure element and comprising either a viability estimate or a scope estimate; and
assessing the plurality of assumptions to determine level of risk and wherein producing the infrastructure project estimate is further based at least in part on the level of risk for each assumption.

8. The method of claim 7, further comprising:
modifying the plurality of assumptions; and
adjusting the infrastructure project estimate based on the modified plurality of estimates.

9. The method of claim 7, wherein assessing the plurality of assumptions to determine level of risk comprises applying a risk management technique to each assumption.

10. The method of claim 1, wherein selecting at least one attribute for each infrastructure element comprises:
selecting a work type for each infrastructure element;
selecting at least one level of activity for each infrastructure element, each selected level of activity related to a numeric value;
selecting at least one impact factor for each infrastructure element, each selected impact factor related to a numeric value;
specifying a percentage of reuse for each infrastructure element;
specifying a percentage for each of a first resource level, a second resource level, and a third resource level for each infrastructure element;
specifying lab, time and cost for each infrastructure element; and
wherein producing an infrastructure project estimate based on the processed project model comprises calculating the project cost and duration based, at least in part, on the numeric values for each infrastructure element.

11. The method of claim 10, wherein selecting at least one level of activity for each infrastructure element comprises:
selecting a level of effort for defining requirements for each infrastructure element;
selecting a level of effort for product evaluation for each infrastructure element;
selecting a level of effort for design for each infrastructure element;
selecting a level of effort for testing for each infrastructure element; and
selecting a level of effort for packaging for each infrastructure element.

12. The method of claim 10, wherein selecting at least one impact factor for each infrastructure element comprises:
selecting an impact factor for product familiarity;
selecting an impact factor for product maturity;
selecting an impact factor for product complexity; and
selecting an impact factor for product stability.

13. The method of claim 10 further comprising:
computing a first product of the selected impact factors for each infrastructure element;
computing a first sum of the selected level of efforts for each infrastructure element;
computing a second product of the first product and the first sum for each infrastructure elements; and
wherein calculating the project duration comprises computing a second sum of the one or more second products.

14. The method of claim 13 further comprising:
specifying a procurement time for each infrastructure element; and
adjusting the project duration based at least in part on the procurement time.

15. The method of claim 13 further comprising:
assigning at least one engineering resource value to the project; and
adjusting the project duration based on the assigned engineering resource value.

16. The method of claim 1, wherein producing an infrastructure project estimate based on the processed project model comprises displaying an estimate for each infrastructure element.

17. The method of claim 10 further comprising:
modifying the related numeric value for at least one level of effort; and
modifying the related numeric value for at least one impact factor.

18. Software for producing an infrastructure project estimate operable to:
identify a plurality of infrastructure elements, the infrastructure elements comprising operating environments, software, interfaces, service, and documentation;
load a project model with the plurality of infrastructure elements;
select at least one attribute for each infrastructure element in the project model;
process at least a portion of the project model based, at least in part, on each selected attribute; and
produce an infrastructure project estimate based, at least in part, on the processed project model, the estimate comprising project cost and project duration.

19. The software of claim 18, wherein the software operable to identify a plurality of infrastructure elements comprises the software operable to:
identify operating environments;
identify peer software items; and
identify functional interfaces.

20. The software of claim 19 further operable to create a graphical project diagram based, at least in part, on the identified infrastructure elements.

21. The software of claim 20, wherein the software operable to identify operating environments comprises the software operable to diagram each unique operating environment, each operating environment comprising hardware, operating system software, documentation, add-on software.

22. The software of claim 20, wherein the software operable to identify peer software items comprises the software operable to diagram each software item within one operating environment.

23. The software of claim 20, wherein the software operable to identify functional interfaces comprises the software operable to diagram one interface to represent the one or more functional interfaces between elements.

24. The software of claim 18 further operable to:
create a plurality of assumptions, each assumption linked to an infrastructure element and comprising either a viability estimate or a scope estimate; and
assess the plurality of assumptions to determine level of risk and wherein the software operable to produce the infrastructure project estimate is further based, at least in part, on the level of risk for each assumption.

25. The software of claim 24, further operable to:
modify the plurality of assumptions; and
adjust the infrastructure project estimate based on the modified plurality of estimates.

26. The software of claim 24, wherein the software operable to assess the plurality of assumptions to determine level of risk comprises the software operable to apply a risk management technique to each assumption.

27. The software of claim 18, wherein the software operable to select at least one attribute for each infrastructure element comprises the software operable to:
select a work type for each infrastructure element;
select at least one level of activity for each infrastructure element, each selected level of activity related to a numeric value of effort;
select at least one impact factor for each infrastructure element, each selected impact factor related to a numeric value;
specify a percentage of reuse for each infrastructure element;
specify a percentage for each of a first resource level, a second resource level, and a third resource level for each infrastructure element;
specify lab time and cost for each infrastructure element; and
wherein the software operable to produce an infrastructure project estimate based on the processed project model comprises the software operable to calculate the project cost and duration based, at least in part, on the numeric values for each infrastructure element.

28. The software of claim 27, wherein the software operable to select at least one level of effort for each infrastructure element comprises the software operable to:
select a level of effort for defining requirements for each infrastructure element;
select a level of effort for product evaluation for each infrastructure element;
select a level of effort for design for each infrastructure element;
select a level of effort for testing for each infrastructure element; and
select a level of effort for packaging for each infrastructure element.

29. The software of claim 27, wherein the software operable to select at least one impact factor for each infrastructure element comprises the software operable to:
select an impact factor for product familiarity;
select an impact factor for product maturity;
select an impact factor for product complexity; and
select an impact factor for product stability.

30. The software of claim 27 further operable to:
compute a first product of the selected impact factors for each infrastructure element;
compute a first sum of the selected level of efforts for each infrastructure element;
compute a second product of the first product and the second sum for each infrastructure elements; and
wherein the software operable to calculate the project duration comprises the software operable to compute a second sum of the one or more second products.

31. The software of claim 30 further operable to:
specify a procurement time for each infrastructure element; and
adjust the project duration based, at least in part, on the procurement time.

32. The software of claim 30 further operable to:
assign at least one engineering resource value to the project; and
adjust the project duration based on the engineering resource value.

33. The software of claim 18, wherein the software operable to produce an infrastructure project estimate based on the processed project model comprises the software operable to display an estimate for each infrastructure element.

34. The software of claim 27 further operable to:
modify the related numeric value for at least one level of effort; and
modify the related numeric value for at least one impact factor.

35. A system for producing an infrastructure project estimate comprising:
at least one memory operable to store a plurality of infrastructure elements; and
one or more processors collectively operable to identify at least a subset of the plurality of infrastructure elements, the infrastructure elements comprising operating environments, software, interfaces, service, and documentation, load a project model with the subset of infrastructure elements, select at least one attribute for each infrastructure element in the project model, process at least a portion of the project model based on each selected attribute, and produce an infrastructure project estimate with the processed project model, the estimate comprising project cost and project duration.

36. The system of claim 35, wherein the processors operable to identify a subset of the plurality of infrastructure elements comprises the processors operable to:
identify operating environments;
identify peer software items; and
identify functional interfaces.

37. The system of claim 36, the processors further operable to create a graphical project diagram based at least in part on the identified infrastructure elements.

38. The system of claim 35, wherein the processors operable to select at least one attribute for each infrastructure element comprises the processors operable to:
select a work type for each infrastructure element;
select at least one level of activity for each infrastructure element, each selected level of activity related to a numeric value;
select at least one impact factor for each infrastructure element, each selected impact factor related to a numeric value;
specify a percentage of reuse for each infrastructure element;
specify a percentage for each of a first resource level, a second resource level, and a third resource level for each infrastructure element;
specify lab time and cost for each infrastructure element; and
wherein the processors operable to produce an infrastructure project estimate based on the processed project model comprises the processors operable to calculate the project cost and duration based, at least in part, on the numeric values for each infrastructure element.
